(19) United States
(12) Patent Application Publication
(10) Pub. No.: US 2020/0248821 A1
(43) Pub. Date: Aug. 6, 2020

(54) MULTIPLE SEAT TRIM CHOKE VALVE

(71) Applicant: Expro Americas, LLC, Houston, TX (US)

(72) Inventors: Anand Parthasarathy, Cypress, TX (US); Scott Charles, Houston, TX (US)

(21) Appl. No.: 16/269,187

(22) Filed: Feb. 6, 2019

(51) Int. Cl. F16K 3/24; F16K 25/00; F16K 31/53

(52) U.S. Cl. CPC F16K 3/246; F16K 1/44; F16K 31/53; F16K 25/00

(57) ABSTRACT

A choke valve is provided that includes a valve body, a plurality of seats, and a gate. The valve body has an inlet port and an outlet port. The plurality of seats is in communication with the valve body, where each seat has a fluid flow configuration, and the fluid flow configuration for each seat is different from the fluid flow configuration of each of the other seats within the plurality of seats. The gate is linearly translatable along a gate axis. The valve body is configured so that so that one of the plurality of seats at a time is selectively positionable in an engagement position aligned with the gate axis.

### BACKGROUND OF THE INVENTION

### 1. Technical Field

The present disclosure relates to choke valves in general, and to choke valves having more than one trim set in particular.

### 2. Background Information

To produce oil and gas from a subterranean reservoir, a drilling operation is managed using drives, pumps and other equipment. A drillstring with the drill bit rotates and penetrates a formation (e.g., a seabed) by cutting rock formations, creating the well. While drilling, “mud” is pumped into the drillstring to the bottom of the well and returned through an annulus surrounding the drillstring. One of the main challenges related to drilling is to maintain the pressure in the well within certain pressure boundaries.

In many prior art drilling systems, one or more control valves (sometimes referred to as a “choke” or a “choke valve”; hereinafter referred to as a “choke”) are utilized to control mud pressure within the drilling system. Chokes typically have a stationary member (e.g., a seat) and a translating member (a gate). The gate and seat (which may be collectively referred to as a “trim set”) are configured to mate with one another. Movement of the gate relative to the seat varies the state of the choke, either closing the choke or opening the choke in the positional spectrum between 100% closed to 100% open. Even with this ability to vary the fluid flow through the choke, prior art chokes are limited by the size of the trim set (e.g., a one inch trim set, a two inch trim set, a three inch trim set, etc.). Under most fluid flow conditions, a fully open one inch trim set will provide a larger difference in pressure across the choke than a three inch trim set in the same choke valve. To address this issue, it is known for a choke to be configured to accept different trim sets. For example, a choke may be configured so that the user can install a first trim set (e.g., a one inch mating gate and seat pair). If the user elects to operate the choke within a different control realm, the user may replace the first trim set with a second trim set (e.g., a two inch mating gate and seat pair), but must disassemble the choke to remove the first trim set and install the second trim set. Although chokes designed to accept a plurality of trim sets are useful, the downside is that the user must take the choke off line, remove the first trim set, install the second trim set, and then bring the choke back on line. This is a labor intensive process and requires a stoppage of the well drilling stop during the remove and replace process, or requires the drilling system have a secondary choke that can be used while the primary choke is being reconfigured. The issue of removing and replacing choke trim sets can be avoided by installing multiple chokes each having a different trim set. The downside of this approach includes the cost of multiple chokes, the piping and control system required to utilize the multiple chokes, and the space on the drilling platform consumed by the multiple chokes and associated piping/controls.

What is needed is a choke that overcomes the problems associated with the prior art chokes.

### SUMMARY

According to an aspect of the present disclosure, a choke valve is provided that includes a valve body, a plurality of seats, and a gate. The valve body has an inlet port and an outlet port. The plurality of seats is in communication with the valve body, where each seat has a fluid flow configuration, and the fluid flow configuration for each seat is different from the fluid flow configuration of each of the other seats within the plurality of seats. The gate is linearly translatable along a gate axis. The valve body is configured so that so that one of the plurality of seats at a time is selectively positionable in an engagement position aligned with the gate axis.

In any of the aspects or embodiments described above and herein, the gate may be configured to mate with each of the plurality of seats.

In any of the aspects or embodiments described above and herein, each of the plurality of seats may have at least one seat sealing surface, and the gate may have at least one gate sealing surface configured to mate with the at least one seat sealing surface of the respective seat.

In any of the aspects or embodiments described above and herein, the fluid flow configuration of each seat may be a fluid flow passage cross-sectional area, and the fluid flow passage cross-sectional area of each seat is different from the fluid flow passage cross-sectional area of each of the other seats within the plurality of seats.

In any of the aspects or embodiments described above and herein, the gate may be configured to mate with each of the plurality of seats in a full mated engagement that prevents fluid flow between the inlet port and the outlet port of the choke valve.

In any of the aspects or embodiments described above and herein, each of the plurality of seats may be disposed within a seat block that is linearly translatable within the valve body, and the seat block is selectively positionable within the valve body so that one of the plurality of seats at a time is in said engagement position aligned with the gate axis.

In any of the aspects or embodiments described above and herein, a fluid pressure source may be utilized to selectively position the seat block within the valve body.

In any of the aspects or embodiments described above and herein, each of the plurality of seats may be disposed within a seat turret that is rotatably mounted relative to the valve body, and the seat turret is selectively positionable within the valve body so that one of the plurality of seats at a time is in said engagement position aligned with the gate axis.

In any of the aspects or embodiments described above and herein, the seat turret may be rotatable about a second axis that is parallel to, and displaced from the gate axis.

In any of the aspects or embodiments described above and herein, each of the plurality of seats may be disposed along the gate axis within the valve body.

In any of the aspects or embodiments described above and herein, at least one of the plurality of seats disposed along the gate axis within the valve body may be configurable in said engagement position and a non-engagement position.

In any of the aspects or embodiments described above and herein, the at least one of the plurality of seats disposed along the gate axis within the valve body may have a plurality of portions, and in the engagement position the plurality of portions are coupled to collectively form the respective seat.

In any of the aspects or embodiments described above and herein, wherein in the non-engagement position, the plurality of portions of the respective at least one of the plurality of seats may be positioned a distance radially away from the gate axis sufficient to present engagement of the plurality of portions of that seat and the gate.

In any of the aspects or embodiments described above and herein, the choke valve may further include a gate stem attached to the gate and a worm gear drive, and the worm gear drive is configured to linearly translate the gate stem and gate.

In any of the aspects or embodiments described above and herein, the worm gear drive may be configured for manual operation, or powered operation, or both.

In any of the aspects or embodiments described above and herein, each combination of the gate and a respective one of the plurality of seats may have a Cv curve associated therewith, and the Cv curve for each combination of the gate and respective one of the plurality of seats is different from the Cv curve for the other combinations of the gate and other respective ones of the plurality of seats.

According to another aspect of the present invention, a choke valve is provided that includes a valve body and a plurality of mating seat and gate pairs. The valve body has an inlet port and an outlet port. The plurality of mating seat and gate pairs are in communication with the valve body. The valve body is configured such that one of the mating seat and gate pairs is in fluid communication with the inlet port and the outlet port at a time. Each mating gate and seat pair has a fluid flow configuration, and the fluid flow configuration for each mating seat and gate pair is different from the fluid flow configuration of each of the other mating seat and gate pairs within the plurality of mating seat and gate pairs.

In any of the aspects or embodiments described above and herein, the plurality of mating seat and gate pairs may include a plurality of seats.

In any of the aspects or embodiments described above and herein, the plurality of mating seat and gate pairs may include a gate configured to mate with each of the plurality of seats.

In any of the aspects or embodiments described above and herein, each of the plurality of seats may have a fluid flow passage cross-sectional area, and the fluid flow passage cross-sectional area of each seat is different from the fluid flow passage cross-sectional area of each of the other seats within the plurality of seats.

In any of the aspects or embodiments described above and herein, each mating seat and gate pair may have a Cv curve associated therewith, and the Cv curve for each mating seat and gate pair is different from the Cv curve for the other mating seat and gate pairs.

According to an aspect of the present disclosure, a choke valve is provided that includes a valve body, a first seat, a second seat, and a gate. The valve body has an inlet port and an outlet port. The first seat is in communication with the valve body, and has a first fluid flow passage cross-sectional area. The second seat is in communication with the valve body, and has a second fluid flow passage cross-sectional area. The first fluid flow passage cross-sectional area is larger than the second fluid flow passage cross-sectional area. The gate is linearly translatable along a gate axis. The valve body is configured so that so that the first seat and the second seat are each selectively positionable in an engagement position aligned with the gate axis, and an out of engagement position.

### BRIEF DESCRIPTION OF THE DRAWINGS

FIG. 1 is a diagrammatic view of a choke valve shown in a closed configuration.

FIG. 1A is a diagrammatic view of the choke valve shown in FIG. 1 in an open configuration.

FIG. 2 is a graphic representation of a single Cv curve, having Cv values versus percent open values of a choke valve.

FIG. 2A is a graphic representation of a plurality of Cv curves, each having Cv values versus percent open values of a gate/seat combination within a choke valve.

FIG. 3 is a diagrammatic representation of a choke valve embodiment according to the present disclosure.

FIG. 4 is a diagrammatic perspective view of a gate embodiment.

FIG. 4A is a diagrammatic sectional view of the gate embodiment shown in FIG. 4.

FIG. 5 is a diagrammatic representation of a choke valve embodiment according to the present disclosure.

FIG. 5A is a diagrammatic sectioned view of the choke valve embodiment shown in FIG. 5.

FIG. 6 is a diagrammatic representation of a choke valve embodiment according to the present disclosure.

### DETAILED DESCRIPTION

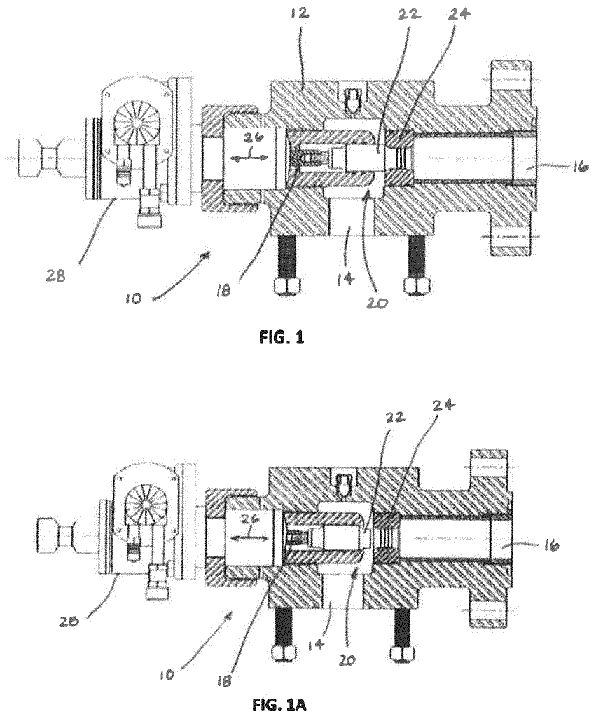

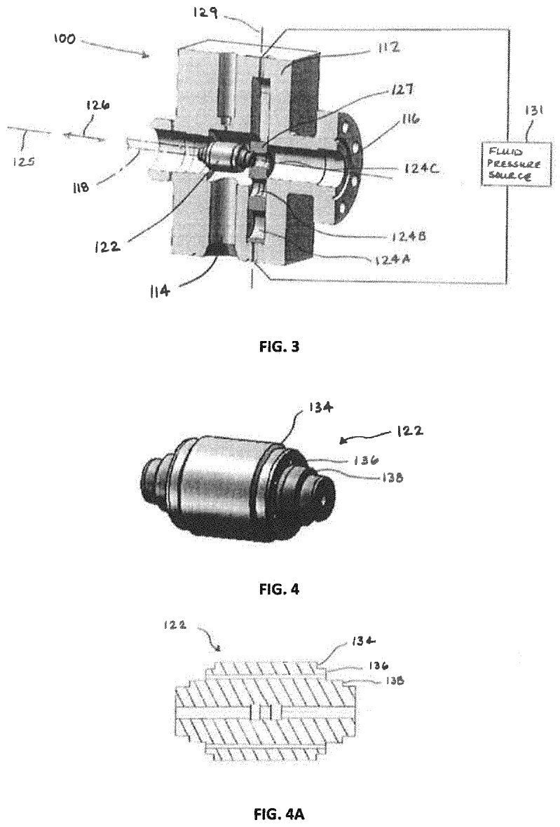

Referring to FIGS. 1 and 1A, a proportional control valve (“choke”) 10 is shown that includes a valve body 12 having an inlet port 14 and an outlet port 16, a gate stem 18, and a trim set 20. The choke shown in FIG. 1 includes a trim set 20 having a single gate 22 and a single seat 24. As will be explained below, embodiments of the present disclosure include chokes 100, 200, 300 having a trim set that includes a gate and a plurality of seats (e.g., see FIGS. 3-6). The gate is configured to mate with each seat, such that full mated engagement of the gate within the respective seat creates a sealed structure that prevents fluid flow there through. In some instances there may be some amount of fluid leakage permitted across the choke (e.g., permissible leakage, or fluid flow across the choke to avoid captured fluid preventing the gate movement, etc.), but any such fluid leakage is inconsequential in terms of a fluid pressure difference across the choke.

The gate stem 18 is configured for linear translation within the valve body 12 (e.g., see arrow 26); in a first direction toward a seat 24 and in an opposite second direction away from the aforesaid seat 24. In some embodiments, the gate stem 18 may be in communication with a worm gear drive 28. The worm gear drive 28 includes an input shaft and an output shaft (not shown). Rotation of the input shaft of the worm gear drive 28 in a first rotational direction (e.g., clockwise) causes linear translation of the output shaft of the worm gear drive 28 (and the connected gate stem 18 and gate 22) in a first linear direction. Rotation of the input shaft of the worm gear drive 28 in a second rotational direction (e.g., counter clockwise) causes linear translation of the output shaft of the worm gear drive 28 (and the connected gate stem 18 and gate 22) in a second linear direction (i.e., opposite the first linear direction). The worm gear drive 28 provides torque multiplication and speed reduction, and also resists back driving of the gate stem 18 and gate 22. In a manual operated choke, the input shaft of the worm gear drive 28 may be connected with a hand wheel (not shown) that enables the user to turn input shaft. In a powered choke, the input shaft of the worm gear drive 28 may be connected with an electric motor drive directly, or indirectly through a gearbox. In those powered choke embodiments that include a gearbox, the gearbox may be configured to provide torque multiplication and speed reduction. The present disclosure is not limited to worm gear drives 28 for producing linear translation of the gate stem 18 and gate 22. Embodiments of the present disclosure may, however, include manually operated chokes and powered chokes, including those that utilize a worm gear drive 28.

The gate 22 is linearly translatable between a fully closed position where zero fluid flow (0% flow) is permitted between the inlet port 14 and the outlet port 16, and a fully open position where a maximum fluid flow (100% flow) is permitted between the inlet port 14 and the outlet port 16, and a continuum of positions there between. The choke 10 shown in FIG. 1 is depicted with a gate 22 in full mated engagement with the seat 24 (i.e., fully closed—no fluid flow through the choke 10). The choke 10 shown in FIG. 1A is depicted with a gate 22 withdrawn a distance from the seat 24 (i.e., open to some degree, thereby allowing fluid flow through the choke 10). The continuum of different positions between the fully closed and open positions enable the operator to vary (manually or in a powered mode) the amount of fluid flow that can be passed through the choke 10; e.g., positions associated with 10%, or 20%, or 30%, etc. of the maximum flow through the choke 10. As will be explained below, embodiments of the present disclosure chokes 100, 200, 300 include a plurality of seats, each having different flow configurations (e.g., a first seat having a flow passage with a 1.5 inch diameter, a second seat having a flow passage with a 2.0 inch diameter, a third seat having a flow passage with a 2.5 inch diameter, a fourth seat having a flow passage with a 3.0 inch diameter, etc.), and the maximum fluid flow through the choke will vary depending on the particular seat selected. The exemplary seats are described above in terms of a flow passage diameter. The present disclosure is not limited to circular seats having a diameter (e.g., differences in flow passages may also be described in terms of differences in flow passage cross-sectional area) or seats having any particular cross-sectional area.

As stated above, embodiments of the present disclosure chokes have a trim set that includes a gate and a plurality of seats. The gate and plurality of seats permit a present disclosure choke to be operated in a plurality of different operating conditions, each with a different trim configuration (e.g., a different fluid flow parameter, such as a seat flow passage size) and associated flow coefficient (“C,”). Chokes are typically defined in terms of the parameters of the fluid flow passing through the choke. The relationship between the volumetric fluid flow rate (“Q”) through a choke, a difference in pressure across the choke (“ΔP”), and the specific gravity (“SG”) of the fluid passing through the choke may be identified in terms of a flow coefficient (“Cv”) for example by the following equation:

$${C}_{v} = Q \sqrt{\frac{SG}{Δ P}} \qquad Eqn . 1$$

The volumetric fluid flow (“Q”) through the choke, the difference in pressure across the choke (“ΔP”), and the specific gravity (“SG”) of the fluid flowing through the choke may be viewed as operational parameters; i.e., parameters dictated by the end use application of the choke. The flow coefficient Cv of the choke, on the other hand, may be viewed as a characteristic of the choke that may vary as a function of the other parameters. The volumetric fluid flow rate (“Q”) through the choke (as considered within this Eqn. 1) refers to the zero to one hundred percent (0-100%) fluid flow for a given gate and seat combination.

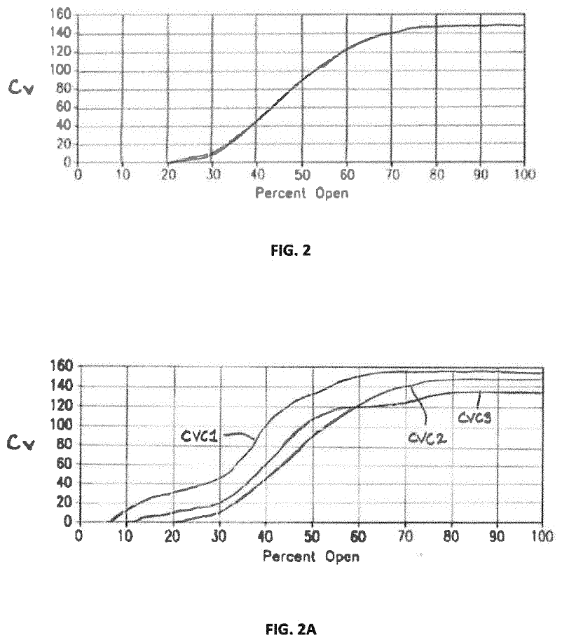

The relationship between the flow coefficient Cv of a choke and the valve opening percentage (i.e., choke position) of the same choke is typically unique to that particular model choke valve. FIG. 2 illustrates a graph having a single trim flow curve (sometimes referred to as a “Cv curve”) with Cv values on a Y-axis and valve percent open on the X-axis. Hence, a prior art choke that has a single gate and seat would have a single associated Cv curve. Embodiments of the present disclosure choke with a trim set that includes a gate and a plurality of seats (i.e., each seat with a different size flow passage) may have a Cv curve associated with each gate and seat combination. FIG. 2A illustrates a graph having a plurality of Cv curves with Cv values on a Y-axis and valve percent open on the X-axis. Each Cv curves (CVC1, CVC2, CVC3), shown in FIG. 2A represents a different gate and seat combination within the choke. Hence, the present disclosure choke embodiments provide a considerably greater operational ability than prior art single trim set chokes, and the Cv curve for each gate and seat combination within a present disclosure choke can be used in the control of the choke. The present disclosure is not limited to a graphic representation of a Cv curve; e.g., the relationship between the Cv values and valve percent open values (generically referred to as a “Cv curve”) may be in algorithmic form, tabular form, etc.

To illustrate the utility and scope of the present disclosure, non-limiting examples of embodiments of the present disclosure are provided below.

Referring to FIG. 3, in a first embodiment, the choke 100 is configured with a valve body 112, an inlet port 114, an outlet port 116, a gate stem 118 (shown in phantom line), a gate 122 and a plurality of seats; e.g., a first seat 124A, a second seat 124B, and a third seat 124C. The gate stem 118 and the gate 122 are linearly translatable along an axis 125 in directions shown by arrow 126. Each seat is configured with a respective flow orifice having a respective diameter and at least one sealing surface (i.e., a “seat sealing surface”) for engagement with the gate 122 as will be explained below; e.g., the first seat 124A is configured with a first flow orifice having a first diameter, the second seat 124B is configured with a second flow orifice having a second diameter, and the third seat 124C is configured with a third flow orifice having a third diameter, wherein the first diameter is larger than the second diameter, and the second diameter is larger than the third diameter. The first, second, and third seats 124A, 124B, 124C are disposed within a seat block 127 that is linearly translatable within the valve body 112. The seat block 127 is linearly translatable along an axis 129 that is perpendicular to the linear translation axis 125 of the gate 122 and gate stem 118. In the embodiment shown in FIG. 3, the first, second, and third seats 124A, 124B, 124C are sequentially disposed within the seat block 127, with the second seat 124B is disposed between the first and third seats 124A, 124C. The valve body 112 is configured so that the seat block 127 may be translated to selectively position each of the seats 124A, 124B, 124C (one at a time) into an engagement position, and in the engagement position the respective seat is aligned with the linear translation axis 125 of the gate 122 and gate stem 118. Hence, when one seat is aligned with the gate axis 125 that seat is disposed in an engagement position, and the other two seats are disposed in non-engagement positions.

The present disclosure is not limited to any particular mechanism for linearly actuating the seat block 127 to position a given seat into an engagement position (and the other seats into out-of-engagement positions). As an example, the seat block may be actuated by fluid pressure from a fluid pressure source 131. Alternatively, the seat block 127 may be coupled with an actuator (e.g., an electric, pneumatic, or hydraulic actuator; not shown) that linearly translates the seat block 127.

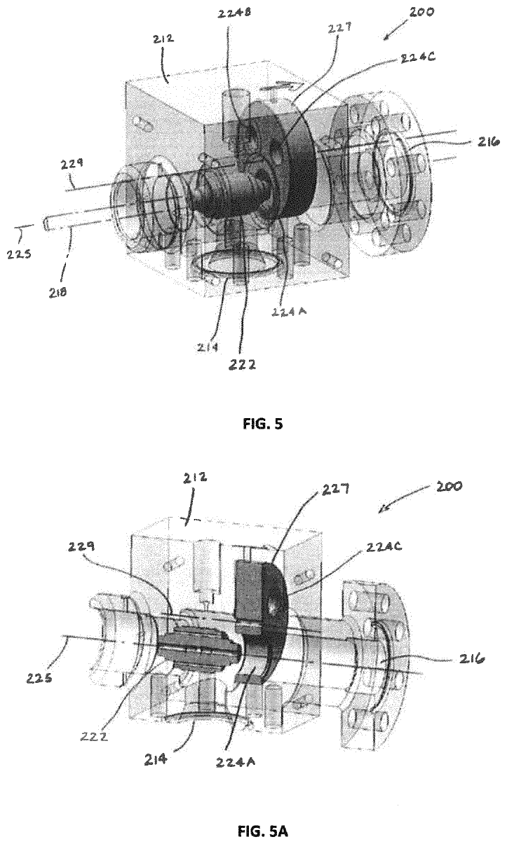

Referring to FIGS. 4 and 4A, the gate 122 utilized with the first embodiment of the multi-seat choke 100 is configured to be attached to a gate stem 118 (see FIG. 3) and is configured with multiple sealing surfaces (i.e., “gate sealing surfaces”); e.g., at least one first sealing surface 134 configured for engaging and sealing with the first seat 124A, at least one second sealing surface 136 configured for engaging and sealing with the second seat 124B, and at least one third sealing surface 138 configured for engaging and sealing with the third seat 124C. Each gate sealing surface(s) is configured to mate with a corresponding seat sealing surface(s) of the respective seat to permit a full mated engagement of the gate 122 with the respective seat 124A, 124B, 124C that prevents fluid flow through the choke 100 (although as stated above, in some instances there may be an inconsequential amount of fluid leakage permitted across the choke 100). The sealing surface 134, 136, 138 configured for engaging and sealing with a particular seat 124A, 124B, 124C may be a single surface or a plurality of surfaces that collectively form the aforesaid seal with the seat 124. Likewise, the seat sealing surface of the respective seat may be a single surface or a plurality of surfaces that collectively form the aforesaid seal with the gate 122. In an alternative embodiment, the gate may have a single sealing surface (e.g., a conical surface) that is configured to mate with all of the seats.

In the operation of this first embodiment of the multi-seat choke 100, the operator may select a particular seat 124A, 124B, 124C to be utilized. A manifold in connection with the choke 100 may be operated to terminate (or prevent) fluid flow through the choke 100; e.g., reroute fluid flow within the well to an alternative choke. Once the choke 100 is isolated, the operator may adjust the choke 100 from a first choke configuration (e.g., wherein the choke 100 is operating with the second seat 124B) to a second choke configuration (e.g., wherein the choke 100 is operating with the third seat 124C). In this particular example, the operator may actuate the seat block 127 to move the second seat 124B out of alignment with the gate axis 125 (i.e., into a non-engagement position), and move the third seat 124C into alignment with the gate axis 125 (i.e., into an engagement position). Subsequently, the gate stem 118 and gate 122 may be linearly actuated to an appropriate position relative to the third seat 124C for operation of the choke 100. If the operator wishes to close the choke 100, the gate stem 118 and gate 122 may be linearly translated to a position wherein the third sealing surface 138 of the gate 122 is in mated engagement with the sealing surface of the third seat 124C. If the operator wishes to open the choke 100, the gate stem 118 and gate 122 may be linearly translated to a position wherein the third sealing surface 138 of the gate 122 is separated from the sealing surface of the third seat, thereby allowing fluid flow across the choke from the input port to the outlet port.

Referring to FIGS. 5 and 5A, in a second embodiment, the choke 200 is configured with a valve body 212, an inlet port 214, an outlet port 216, a gate stem 218 (shown in phantom line), a gate 222 and a plurality of seats; e.g., a first seat 224A, a second seat 224B, and a third seat 224C. Each seat is configured with a respective flow orifice having a respective diameter and at least one sealing surface for engagement with the gate 222 as explained above and herein; e.g., the first seat 224A is configured with a first flow orifice having a first diameter, the second seat 224B is configured with a second flow orifice having a second diameter, and the third seat 224C is configured with a third flow orifice having a third diameter, wherein the third diameter is larger than the second diameter, and the second diameter is larger than the first diameter. The first, second, and third seats 224A, 224B, 224C are disposed within a seat turret 227 disposed that is rotatable within the valve body 212. The seat turret 227 is rotatable about an axis 229 that is parallel with, but displaced from, the linear translation axis 225 of the gate 222 and gate stem 218. In the embodiment shown in FIGS. 5 and 5A, the first, second, and third seats 224A, 224B, 224C are disposed at different circumferential positions within the seat turret 227. The valve body 212 is configured so that the seat turret 227 may be rotated to one of the seats 224A, 224B, 224C with the linear translation gate axis 225. Hence, when one seat is aligned with the gate axis 225 that seat is disposed in an engagement position, and the other two seats are disposed in non-engagement positions.

The present disclosure is not limited to any particular mechanism for rotating the seat turret 227 to position a given seat into an engagement position (and the other seats into out-of-engagement positions). As an example, the seat turret 227 may be coupled with an actuator (e.g., an electric, pneumatic, or hydraulic rotary actuator), directly or indirectly in communication with the seat turret 227, configured to selectively rotate the seat turret 227. The specific rotational positioning of the seat turret 227 may be determined, for example, using an encoder in communication with the seat turret 227 or with the actuator.

The gate 222 utilized with the second embodiment of the multi-seat choke 200 may be the same as or similar to the gate embodiment described above in the first embodiment (e.g., See FIGS. 4 and 4A) i.e., a gate configured to be attached to a gate stem and configured with multiple sealing surfaces. Each gate sealing surface is configured to mate with a corresponding seat sealing surface of the respective seat to permit a full mated engagement of the gate with the respective seat that prevents fluid flow there through, or alternatively be separated from the seat to allow fluid flow through the ports of the choke. The sealing surface configured for engaging and sealing with a particular seat may be a single surface or a plurality of surfaces that collectively form the aforesaid seal with the seat.

In the operation of this second embodiment of the multi-seat choke 200, the operator may select a particular seat 224A, 224B, 224C to be utilized. A manifold in connection with the choke 200 may be operated to terminate (or prevent) fluid flow through the choke 200; e.g., reroute fluid flow within the well to an alternative choke. Once the choke 200 is isolated, the operator may adjust the choke 200 from a first choke configuration (e.g., wherein the choke 200 is operating with the second seat 224B) to a second choke configuration (e.g., wherein the choke 200 is operating with the third seat 224C). In this particular example, the operator may actuate the seat turret 227 to rotate the second seat 224B out of alignment with the gate axis 225 (i.e., into a non-engagement position), and move the third seat 224C into alignment with the gate axis 225 (i.e., into an engagement position). Subsequently, the gate stem 218 and gate 222 may be linearly actuated to an appropriate position relative to the third seat 224C for operation of the choke 200. If the operator wishes to close the choke 200, the gate stem 218 and gate 222 may be linearly translated to a position wherein the third sealing surface of the gate 222 is in mated engagement with the sealing surface of the third seat 224C. If the operator wishes to open the choke 200, the gate stem 218 and gate 222 may be linearly translated to a position wherein the third sealing surface of the gate 222 is separated from the sealing surface of the third seat 224C, thereby allowing fluid flow across the choke 200 from the input port 214 to the outlet port 216.

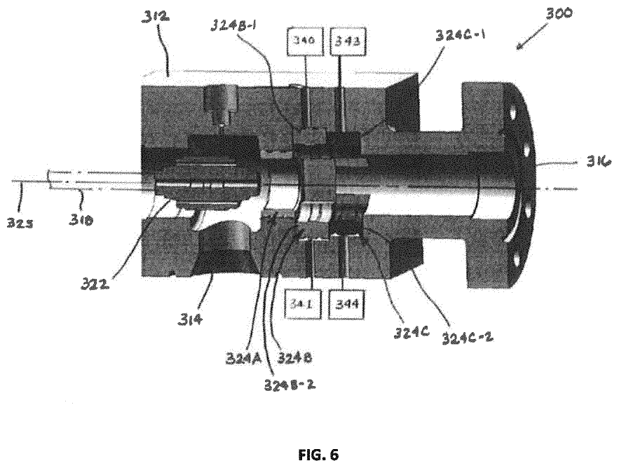

Referring to FIG. 6, in a third embodiment, the choke is configured with a valve body 312, an inlet port 314, an outlet port 316, a gate stem 318 (shown in phantom line), a gate 322 and a plurality of seats; e.g., a first seat 324A, a second seat 324B, and a third seat 324C. Each seat is configured with a respective flow orifice having a respective diameter and at least one sealing surface for engagement with the gate as will be explained below and herein; e.g., the first seat 324A is configured with a first flow orifice having a first diameter, the second seat 324B is configured with a second flow orifice having a second diameter, and the third seat 324C is configured with a third flow orifice having a third diameter, wherein the third diameter is larger than the second diameter, and the second diameter is larger than the first diameter. The first, second, and third seats 324A, 324B, 324C are linearly arranged within the valve body 312 along the linear translation axis 325 of the gate 322 and gate stem 318; e.g., the first seat 324A is disposed closest to the inlet port 314, the third seat 324C is disposed farthest away from the inlet port 314, and the second seat 324B is disposed between the first and third seats 324A, 324C. The second and third seats 324B, 324C are configured in a split configuration; e.g., a first portion 324B-1, 324C-1 and a second portion 324B-2, 324C-2. In FIG. 6, the first seat 324A is shown as a unitary structure. However, in alternative configurations the first seat 324A may also have a split configuration. The valve body 312 is configured so that the respective seat portions 324B-1, 324B-2, 324C-1, 324C-2 may be translated between an engagement position and an out-of-engagement position. In the engagement position, the first and second seat portions of the respective seat are coupled together, and the respective first and second seat portions collectively form the respective flow orifice and diameter. In the engagement position, the diameter formed by the coupled first and second seat portions of the respective seat is centered on the linear translation axis 325 of the gate 322 and gate stem 318. In the out-of-engagement position, the respective first and second seat portions are uncoupled from one another; e.g., drawn radially outward from the linear translation axis 325 of the gate 322 and gate stem 318. In the out-of-engagement position, the first and second seat portions are positioned so they will not engage the gate 322, regardless of the axial position of the gate 322.

The present disclosure is not limited to any particular mechanism for actuating the first and second seat portions 324B-1, 324B-2, 324C-1, 324C-2 between the engagement position and the out-of-engagement position. As an example, the first seat portion 324B-1 of the second seat 324B may be coupled with a first actuator 340 (e.g., an electric, pneumatic, or hydraulic actuator) that moves the first seat portion 324B-1 between the engagement position and the out of engagement position, and the second seat portion 324B-2 may be coupled with a second actuator 341 (e.g., an electric, pneumatic, or hydraulic actuator) that moves the second seat portion 324B-2 between the engagement position and the out of engagement position (a similar arrangement can be used for the third seat portions 324C-1, 324C-1; e.g., actuators 343, 344). Hence, the first and second actuators 340, 341 can be controlled in concert to move the respective seat portions 324B-1, 324B-2 between the engagement position and the out of engagement position. The present disclosure is not limited to a seat having two seat portions or seat portions that are actuated by two actuators; e.g., a seat portion may have a plurality of seat portions and a plurality of actuators. As another example, the first and second seat portions of the respective seat may be biased (e.g., by springs, magnetic attraction, etc.) in the out of engagement position, and may be translatable into the engagement position by a fluid pressure source (e.g., hydraulic, pneumatic, etc.) that drives the first and second seat portions of the respective seat into the engagement position. As stated above, these are examples of a mechanism for actuating the first and second seat portions between the engagement position and the out-of-engagement position and the present disclosure is not limited thereto.

The gate 322 utilized with the third embodiment of the multi-seat choke 300 may be the same as or similar to the gate embodiment described above in the first and second embodiments (e.g., See FIGS. 4 and 4A) i.e., a gate configured to be attached to a gate stem and configured with multiple sealing surfaces. Each sealing surface is configured to mate with a corresponding sealing surface of the respective seat to permit a full mated engagement of the gate with the respective seat that prevents fluid flow there through. The sealing surface configured for engaging and sealing with a particular seat may be a single surface or a plurality of surfaces that collectively form the aforesaid seal the seat.

In the operation of this third embodiment of the multi-seat choke 300, a selection may be made regarding the particular seat 324A, 324B, 324C to be utilized. A manifold in connection with the choke 300 may be operated to terminate (or prevent) fluid flow through the choke 300; e.g., reroute fluid flow within the well to an alternative choke. Once the choke 300 is isolated, the operator may adjust the choke 300 from a first choke configuration (e.g., wherein the choke 300 is operating with the second seat 324B) to a second choke configuration (e.g., wherein the choke 300 is operating with the third seat 324C). In this particular example, the operator may actuate the first and second seat portions 324B-1, 324B-2 of the second seat 324B from the engagement position to the out-of-engagement position. The operator also actuates the first and second seat portions 324C-1, 324C-2 of the third seat 324C from an out-of-engagement position to the engagement position. Subsequently, the gate stem 318 and gate 322 may be linearly actuated to an appropriate position relative to the third seat 324C for operation of the choke 300. If the operator wishes to close the choke 300, the gate stem 318 and gate 322 may be linearly translated to a position wherein the third sealing surface of the gate 322 is in mated engagement with the sealing surface of the third seat 324C. If the operator wishes to open the choke 300, the gate stem 318 and gate 322 may be linearly translated to a position wherein the third sealing surface of the gate 322 is separated from the sealing surface of the third seat 324C, thereby allowing fluid flow across the choke 300 from the input port 314 to the outlet port 316. Fluid flow is permitted through those seats not being utilized by the choke 300.

Embodiments of the present disclosure have been described above in terms of a seat block 127 and a seat turret 227 (each having a plurality of seats), and multiple independent seats each having two seat portions, any and all of which may be actuated to change the operating configuration of the choke 100, 200, 300. In the description above, the description has generically described the choke operator as involved in the actuation of the respective components. The present disclosure contemplates that the aforesaid components may be actuated manually or automatically, and is not limited to either. A choke embodiment that is configured to “automatically” change choke seats may include hardware and a controller that is configured with instructions (e.g., in the form of software) stored within a memory device. The instructions when implemented by the controller and the hardware cause the choke to change from a first gate/seat configuration to a second gate/seat configuration, etc.

While the invention has been described with reference to exemplary embodiments, it will be understood by those skilled in the art that various changes may be made and equivalents may be substituted for elements thereof without departing from the scope of the invention. In addition, many modifications may be made to adapt a particular device configurations to the teachings of the invention without departing from the essential scope thereof. Therefore, it is intended that the invention not be limited to the particular embodiment(s) disclosed herein as the best mode contemplated for carrying out this invention.

What is claimed is:

1. A choke valve, comprising:
a valve body having an inlet port and an outlet port;
a plurality of seats in communication with the valve body, where each seat has a fluid flow configuration, and the fluid flow configuration for each seat is different from the fluid flow configuration of each of the other seats within the plurality of seats; and
a gate linearly translatable along a gate axis;
wherein the valve body is configured so that so that one of the plurality of seats at a time is selectively positionable in an engagement position aligned with the gate axis.

2. The choke valve of claim 1, wherein the gate is configured to mate with each of the plurality of seats.

3. The choke valve of claim 2, wherein each of the plurality of seats has at least one seat sealing surface, and the gate has at least one gate sealing surface configured to mate with the at least one seat sealing surface of the respective seat.

4. The choke valve of claim 1, wherein the fluid flow configuration of each seat is a fluid flow passage cross-sectional area, and the fluid flow passage cross-sectional area of each seat is different from the fluid flow passage cross-sectional area of each of the other seats within the plurality of seats.

5. The choke valve of claim 1, wherein the gate is configured to mate with each of the plurality of seats in a full mated engagement that prevents fluid flow between the inlet port and the outlet port of the choke valve.

6. The choke valve of claim 1, wherein each of the plurality of seats is disposed within a seat block that is linearly translatable within the valve body, and the seat block is selectively positionable within the valve body so that one of the plurality of seats at a time is in said engagement position aligned with the gate axis.

7. The choke valve of claim 1, wherein each of the plurality of seats is disposed within a seat turret that is rotatably mounted relative to the valve body, and the seat turret is selectively positionable within the valve body so that one of the plurality of seats at a time is in said engagement position aligned with the gate axis.

8. The choke valve of claim 7, wherein the seat turret is rotatable about a second axis that is parallel to, and displaced from the gate axis.

9. The choke valve of claim 1, wherein each of the plurality of seats is disposed along the gate axis within the valve body.

10. The choke valve of claim 9, wherein at least one of the plurality of seats disposed along the gate axis within the valve body is configurable in said engagement position and a non-engagement position.

11. The choke valve of claim 10, wherein the at least one of the plurality of seats disposed along the gate axis within the valve body has a plurality of portions, and in the engagement position the plurality of portions are coupled to collectively form the respective seat.

12. The choke valve of claim 11, wherein in the non-engagement position, the plurality of portions of the respective at least one of the plurality of seats are positioned a distance radially away from the gate axis sufficient to present engagement of the plurality of portions of that seat and the gate.

13. The choke valve of claim 1, further comprising a gate stem attached to the gate and a worm gear drive, and the worm gear drive is configured to linearly translate the gate stem and gate.

14. The choke valve of claim 13, wherein the worm gear drive is configured for manual operation, or powered operation, or both.

15. The choke valve of claim 1, wherein each combination of the gate and a respective one of the plurality of seats has a Cv curve associated therewith, and the Cv curve for each combination of the gate and respective one of the plurality of seats is different from the Cv curve for the other combinations of the gate and other respective ones of the plurality of seats.

16. A choke valve, comprising:
a valve body having an inlet port and an outlet port; and
a plurality of mating seat and gate pairs in communication with the valve body, where each mating gate and seat pair has a fluid flow configuration, and the fluid flow configuration for each mating seat and gate pair is different from the fluid flow configuration of each of the other mating seat and gate pairs within the plurality of mating seat and gate pairs.

17. The choke valve of claim 16, wherein the plurality of mating seat and gate pairs includes a single gate and a plurality of seats.

18. The choke valve of claim 16, wherein each of the plurality of seats has a fluid flow passage cross-sectional area, and the fluid flow passage cross-sectional area of each seat is different from the fluid flow passage cross-sectional area of each of the other seats within the plurality of seats.

19. The choke valve of claim 16, wherein each mating seat and gate pair has a Cv curve associated therewith, and the Cv curve for each mating seat and gate pair is different from the Cv curve for the other mating seat and gate pairs.

20. A choke valve, comprising:
a valve body having an inlet port and an outlet port;
a first seat in communication with the valve body, the first seat having a first fluid flow passage cross-sectional area;
a second seat in communication with the valve body, the second seat having a second fluid flow passage cross-sectional area;
wherein the first fluid flow passage cross-sectional area is larger than the second fluid flow passage cross-sectional area; and
a gate linearly translatable along a gate axis;
wherein the valve body is configured so that so that the first seat and the second seat are each selectively positionable in an engagement position aligned with the gate axis, and an out of engagement position.
